(19) United States
(12) Patent Application Publication
(10) Pub. No.: US 2026/0155093 A1
(43) Pub. Date: Jun. 4, 2026

(54) DISPLAY DEVICE, METHOD OF DRIVING THE SAME, AND ELECTRONIC DEVICE INCLUDING THE SAME

(71) Applicant: Samsung Display Co., LTD., Yongin-si (KR)

(72) Inventors: HONG-KYU KIM, Yongin-si (KR); YOUNGWOON CHOI, Yongin-si (KR); SEYUN KIM, Yongin-si (KR); SUNGJAE PARK, Yongin-si (KR); SEUNGHO PARK, Yongin-si (KR); NAMJAE LIM, Yongin-si (KR)

(21) Appl. No.: 19/356,431

(22) Filed: Oct. 13, 2025

(30) Foreign Application Priority Data
Dec. 4, 2024 (KR) 10-2024-0178275

(51) Int. Cl. G09G 3/32

(52) U.S. Cl. CPC G09G 3/32; G09G 2310/0245; G09G 2310/0267; G09G 2310/0275; G09G 2310/08; G09G 2320/0247; G09G 2320/0626; G09G 2330/021; G09G 2360/16

(57) ABSTRACT

A display device includes a display panel including a pixel, a data driver which provides a data voltage to the pixel, a scan driver providing first and second scan signals to the pixel, and a controller which controls the data driver and the scan driver. The controller includes a first selection block which selects one of a data compensation method and a scan compensation method as a first method by determining whether an image includes a ghost, a second selection block which selects one of the data compensation method and the scan compensation method as a second method by determining a luminance of the image, a third selection block which selects one of the data compensation method and the scan compensation method as a third method by determining a frequency difference, and a determination block which determines one of the first to third methods as a luminance compensation method.

This application claims priority to Korean Patent Application No. 10-2024-0178275, filed on Dec. 4, 2024, and all the benefits accruing therefrom under 35 U.S.C. § 119, the content of which in its entirety is herein incorporated by reference herein.

### BACKGROUND

### 1. Field

Embodiments relate to a display device. More particularly, embodiments relate to a display device driven by a variable refresh rate, a method of driving the display device, and an electronic device including the display device.

### 2. Description of the Related Art

A display device may include a display panel, a data driver, and a scan driver. The display panel may include pixels for displaying an image. The data driver may provide data voltages to the pixels. The scan driver may provide scan signals to the pixels.

The display device may be driven in a variable refresh rate (VRR) mode in which a driving frequency of the display panel may change. When the display device displays a moving image, the driving frequency of the display panel may increase to improve image quality of the display device. When the display device displays a still image, the driving frequency of the display panel may decrease to reduce power consumption of the display device.

### SUMMARY

Embodiments provide a display device with improved image quality and an electronic device including the display device.

Embodiments provide a method of driving a display device for improving image quality of the display device.

A display device according to embodiments includes a display panel including a pixel, a data driver which provides a data voltage to the pixel, a scan driver which provides a first scan signal and a second scan signal to the pixel, and a controller which controls the data driver and the scan driver. In such embodiments, the controller includes a first selection block which selects one of a data compensation method and a scan compensation method as a first method by determining whether an image includes a ghost based on input image data and frequency information, where the data voltage is controlled based on a driving frequency when the data compensation method is performed, and the second scan signal is controlled based on the driving frequency when the scan compensation method is performed, a second selection block which selects one of the data compensation method and the scan compensation method as a second method by determining a luminance of the image based on the input image data, a third selection block which selects one of the data compensation method and the scan compensation method as a third method by determining a frequency difference based on the frequency information, and a determination block which determines one of the first method, the second method, and the third method as a luminance compensation method.

In an embodiment, when the data compensation method is performed, a voltage level of the data voltage may decrease as the driving frequency decreases.

In an embodiment, when the scan compensation method is performed, a number of dummy pulses of the second scan signal within a vertical blank period having a variable time length may increase as the driving frequency decreases.

In an embodiment, the first selection block may select the data compensation method as the first method when the image includes the ghost, and may select the scan compensation method as the first method when the image does not include the ghost.

In an embodiment, the first selection block may determine vertical areas in which a ghost index is greater than or equal to a threshold index as ghost areas among a plurality of vertical areas, may select the data compensation method as the first method when a number of the ghost areas is greater than or equal to a threshold number, and may select the scan compensation method as the first method when the number of the ghost areas is less than the threshold number.

In an embodiment, the first selection block may calculate luminance data including luminance values for a plurality of blocks which divides the image based on the input image data, may calculate a maximum luminance value for each of the vertical areas and a maximum luminance row in which the maximum luminance value is positioned based on the luminance data, may calculate a ghost row for each of the vertical areas based on the maximum luminance row and the frequency information, may calculate an average luminance value corresponding to the ghost row based on the luminance data, and may calculate a ghost index for each of the vertical areas based on the maximum luminance value and the average luminance value.

In an embodiment, the ghost index may increase as a difference between the maximum luminance value and the average luminance value increases, and the ghost index may increase as the average luminance value decreases.

In an embodiment, the second selection block may select the data compensation method as the second method when the luminance of the image is greater than or equal to a reference luminance, and may select the scan compensation method as the second method when the luminance of the image is less than the reference luminance.

In an embodiment, the second selection block may calculate luminance data including luminance values for a plurality of blocks which divides the image based on the input image data, and the luminance of the image may be one of an average value of the luminance values, a maximum value of the luminance values, a minimum value of the luminance values, and a representative value of the luminance values.

In an embodiment, the third selection block may select the data compensation method as the third method when the frequency difference is less than or equal to a reference difference, and may select the scan compensation method as the third method when the frequency difference is greater than the reference difference.

In an embodiment, the frequency difference may be a difference between the driving frequency of a current frame and the driving frequency of a previous frame.

In an embodiment, the determination block may determine the luminance compensation method by referencing a lookup table which stores the luminance compensation method corresponding to the first method, the second method, and the third method.

In an embodiment, the pixel may include a first transistor including a gate connected to a first node, a first terminal which receives a first power voltage, and a second terminal connected to a second node, a second transistor including a gate which receives the first scan signal, a first terminal which receives the data voltage, and a second terminal connected to the first node, a third transistor including a gate which receives the second scan signal, a first terminal which receives a reference voltage, and a second terminal connected to the second node, a capacitor including a first terminal connected to the first node and a second terminal connected to the second node, and a light-emitting diode including a first terminal connected to the second node and a second terminal which receives a second power voltage.

A method of driving a display device according to embodiments includes selecting one of a data compensation method and a scan compensation method as a first method by determining whether an image includes a ghost based on input image data and frequency information, where a data voltage is controlled based on a driving frequency when the data compensation method is performed, and a scan signal is controlled based on the driving frequency when the scan compensation method is performed, selecting one of the data compensation method and the scan compensation method as a second method by determining a luminance of the image based on the input image data, selecting one of the data compensation method and the scan compensation method as a third method by determining a frequency difference based on the frequency information, and determining one of the first method, the second method, and the third method as a luminance compensation method.

In an embodiment, when the data compensation method is performed, a voltage level of the data voltage may decrease as the driving frequency decreases.

In an embodiment, when the scan compensation method is performed, a number of dummy pulses of the scan signal within a vertical blank period having a variable time length may increase as the driving frequency decreases.

In an embodiment, in the selecting one of the data compensation method and the scan compensation method as the first method, the data compensation method may be selected as the first method when the image includes the ghost, and the scan compensation method may be selected as the first method when the image does not include the ghost.

In an embodiment, in the selecting one of the data compensation method and the scan compensation method as the second method, the data compensation method may be selected as the second method when the luminance of the image is greater than or equal to a reference luminance, and the scan compensation method may be selected as the second method when the luminance of the image is less than the reference luminance.

In an embodiment, in the selecting one of the data compensation method and the scan compensation method as the third method, the data compensation method may be selected as the third method when the frequency difference is less than or equal to a reference difference, and the scan compensation method may be selected as the third method when the frequency difference is greater than the reference difference.

An electronic device according to embodiments includes a processor, a memory connected to the processor, a power module connected to the processor, and a display device which receives input image data from the processor, and displays an image corresponding to the input image data. In such embodiments, the display device includes a display panel including a pixel, a data driver which provides a data voltage to the pixel, a scan driver which provides a first scan signal and a second scan signal to the pixel, and a controller which controls the data driver and the scan driver. In such embodiments, the controller includes a first selection block which selects one of a data compensation method and a scan compensation method as a first method by determining whether the image includes a ghost based on the input image data and frequency information, where the data voltage is controlled based on a driving frequency when the data compensation method is performed, and the second scan signal is controlled based on the driving frequency when the scan compensation method is performed, a second selection block which selects one of the data compensation method and the scan compensation method as a second method by determining a luminance of the image based on the input image data, a third selection block which selects one of the data compensation method and the scan compensation method as a third method by determining a frequency difference based on the frequency information, and a determination block which determines one of the first method, the second method, and the third method as a luminance compensation method.

In the display device, the method of driving the display device, and the electronic device according to the embodiments, one of the data compensation method and the scan compensation method is determined as the luminance compensation method by determining whether the image includes the ghost, the luminance of the image, and the frequency difference, so that a luminance deviation according to the change in driving frequency may be reduced using a proper luminance compensation method according to the conditions. Accordingly, the image quality of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a circuit diagram illustrating an example of a pixel of FIG. 1.

FIG. 3 is a signal timing diagram for describing an operation of a pixel at first and second frequencies when luminance compensation is not performed.

FIG. 4 is a signal timing diagram illustrating a luminance of the pixel at the first and second frequencies when the luminance compensation is not performed.

FIG. 5 is a signal timing diagram for describing an operation of the pixel at the first and second frequencies when the luminance compensation is performed by a data compensation method.

FIG. 6 is a signal timing diagram for describing an operation of the pixel at the first and second frequencies when the luminance compensation is performed by a scan compensation method.

FIG. 7 is a graph illustrating a relationship between a driving frequency and a luminance when the luminance compensation is performed by the data compensation method and the scan compensation method when a luminance of a display device is low.

FIG. 8 is a graph illustrating a relationship between a driving frequency and a luminance when the luminance compensation is performed by the data compensation method and the scan compensation method when a luminance of a display device is high.

FIG. 9 is a diagram for describing an image and pixels when an active scan period and a dummy scan period do not overlap each other when the luminance compensation is performed by the scan compensation method.

FIG. 10 is a diagram for describing an image and pixels when the active scan period and the dummy scan period overlap each other when the luminance compensation is performed by the scan compensation method.

FIG. 11 is a block diagram illustrating a controller of FIG. 1.

FIG. 12 is a diagram for describing an operation to calculate luminance data based on input image data.

FIG. 13 is a diagram for describing an operation to calculate maximum luminance values for vertical areas and maximum luminance rows in which the maximum luminance values are positioned based on the luminance data.

FIG. 14 is a diagram for describing an operation to calculate ghost rows for the vertical areas based on the maximum luminance rows and frequency information, and to calculate average luminance values corresponding to the ghost rows based on the luminance data.

FIG. 15 is a diagram for describing an operation to calculate ghost indexes for the vertical area based on the maximum luminance values and the average luminance values.

FIG. 16 is a diagram for describing an operation to select one of the data compensation method and the scan compensation method as a second method by determining a luminance.

FIG. 17 is a diagram for describing an operation to select one of the data compensation method and the scan compensation method as a third method by determining a frequency difference.

FIG. 18 is a diagram illustrating an example of a lookup table which stores a luminance compensation method corresponding to a first method, the second method, and the third method.

FIG. 19 is a flowchart illustrating a method of driving a display device according to an embodiment.

FIG. 20 is a block diagram illustrating an electronic device according to an embodiment.

FIG. 21 is a diagram illustrating electronic devices according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a display device, a method of driving a display device, and an electronic device according to embodiments of the present disclosure will be described in more detail with reference to the accompanying drawings. The same or similar reference numerals will be used for the same elements in the accompanying drawings.

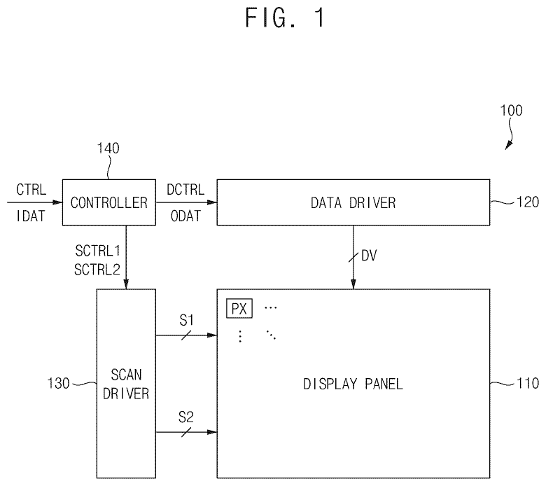

FIG. 1 is a block diagram illustrating a display device 100 according to an embodiment.

Referring to FIG. 1, an embodiment of the display device 100 may include a display panel 110, a data driver 120, a scan driver 130, and a controller 140.

The display panel 110 may include a plurality of data lines, a plurality of first scan lines, a plurality of second scan lines, and a plurality of pixels PX. The data lines may provide data voltages DV to the pixels PX. The first scan lines may provide first scan signals S1 to the pixels PX. The second scan lines may provide second scan signals S2 to the pixels PX. The pixels PX may emit light in response to the data voltages DV, the first scan signals S1, and the second scan signals S2.

The display panel 110 may further include a plurality of reference voltage lines (not shown). The reference voltage lines may provide reference voltages to the pixels PX. In an embodiment, the reference voltage lines may be used as sensing lines for sensing characteristics of the pixels PX.

The display panel 110 may be driven at a driving frequency that varies within a predetermined range. In an embodiment, a mode of the display device 100 that drives the display panel 110 at the variable driving frequency may be referred to as a variable refresh rate (VRR) mode. The variable refresh rate mode may be a free-sync mode, a G-sync mode, etc., but is not limited thereto.

The data driver 120 may provide the data voltages DV to the pixels PX through the data lines. The data driver 120 may generate the data voltages DV based on a data control signal DCTRL and output image data ODAT. In an embodiment, the data control signal DCTRL may include an output data enable signal, a horizontal start signal, and a load signal.

In an embodiment, the data driver 120 and the controller 140 may be implemented as a single integrated circuit, and such an integrated circuit may be referred to as a timing controller embedded data driver (TED). In another embodiment, the data driver 120 and the controller 140 may be implemented as separate integrated circuits.

The scan driver 130 may sequentially provide the first scan signals S1 to the pixels PX through the first scan lines on a pixel row basis, and may sequentially provide the second scan signals S2 to the pixels PX through the second scan lines on a pixel row basis. The scan driver 130 may generate the first scan signals S1 based on a first scan control signal SCTRL1, and may generate the second scan signals S2 based on a second scan control signal SCTRL2. In an embodiment, the first scan control signal SCTRL1 may include a first scan start signal and a first scan clock signal, and the second scan control signal SCTRL2 may include a second scan start signal and a second scan clock signal.

In an embodiment, the scan driver 130 may be formed or mounted in a peripheral area of the display panel 110. In another embodiment, the scan driver 130 may be implemented as at least one integrated circuit.

The controller 140 may control the data driver 120 and the scan driver 130. The controller 140 may provide the output image data ODAT and the data control signal DCTRL to the data driver 120, and may provide the first scan control signal SCTRL1 and the second scan control signal SCTRL2 to the scan driver 130. The controller 140 may generate the output image data ODAT, the data control signal DCTRL, the first scan control signal SCTRL1, and the second scan control signal SCTRL2 based on input image data IDAT and a control signal CTRL. In an embodiment, the input image data IDAT may include red image data, green image data, and blue image data. In an embodiment, the control signal CTRL may include a vertical synchronization signal, a horizontal synchronization signal, an input data enable signal, and a master clock signal. The controller 140 may receive the input image data IDAT and the control signal CTRL from an external processor.

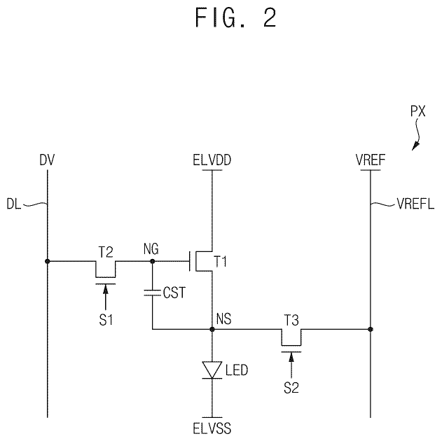

FIG. 2 is a circuit diagram illustrating the pixel PX of FIG. 1.

Referring to FIGS. 1 and 2, an embodiment of the pixel PX may include a first transistor T1, a second transistor T2, a third transistor T3, a capacitor CST, and a light-emitting diode LED. The pixel PX may receive a first scan signal S1, a second scan signal S2, a data voltage DV, a reference voltage VREF, a first power voltage ELVDD, and a second power voltage ELVSS. In an embodiment, a voltage level of the first power voltage ELVDD may be higher than a voltage level of the second power voltage ELVSS. In an embodiment, a voltage level of the reference voltage VREF may be lower than a voltage level of a threshold voltage of the light-emitting diode LED.

The first transistor T1 may generate a driving current corresponding to a voltage difference between a first node NG and a second node NS. The first transistor T1 may include a gate connected to the first node NG, a first terminal (e.g., a drain) that receives the first power voltage ELVDD, and a second terminal (e.g., a source) connected to the second node NS.

The second transistor T2 may transmit the data voltage DV to the first node NG in response to the first scan signal S1. The second transistor T2 may include a gate that receives the first scan signal S1, a first terminal (e.g., a drain) connected to a data line DL that transmits the data voltage DV, and a second terminal (e.g., a source) connected to the first node NG.

The third transistor T3 may transmit the reference voltage VREF to the second node NS in response to the second scan signal S2. The third transistor T3 may include a gate that receives the second scan signal S2, a first terminal (e.g., a drain) connected to a reference voltage line VREFL that transmits the reference voltage VREF, and a second terminal (e.g., a source) connected to the second node NS. In an embodiment, the third transistor T3 may transmit a voltage of the second node NS that reflects characteristics of the first transistor T1 or characteristics of the light-emitting diode LED to the reference voltage line VREFL in response to the second scan signal S2.

In an embodiment, each of the first transistor T1, the second transistor T2, and the third transistor T3 may be an NMOS transistor. In another embodiment, at least one of the first transistor T1, the second transistor T2, and the third transistor T3 may be a P-channel metal-oxide-semiconductor (PMOS) transistor.

The capacitor CST may be connected between the first node NG and the second node NS. The capacitor CST may include a first terminal connected to the first node NG and a second terminal connected to the second node NS.

The light-emitting diode LED may include a first terminal (e.g., an anode) connected to the second node NS and a second terminal (e.g., a cathode) that receives the second power voltage ELVSS. The light-emitting diode LED may emit light with a luminance corresponding to the driving current generated by the first transistor T1.

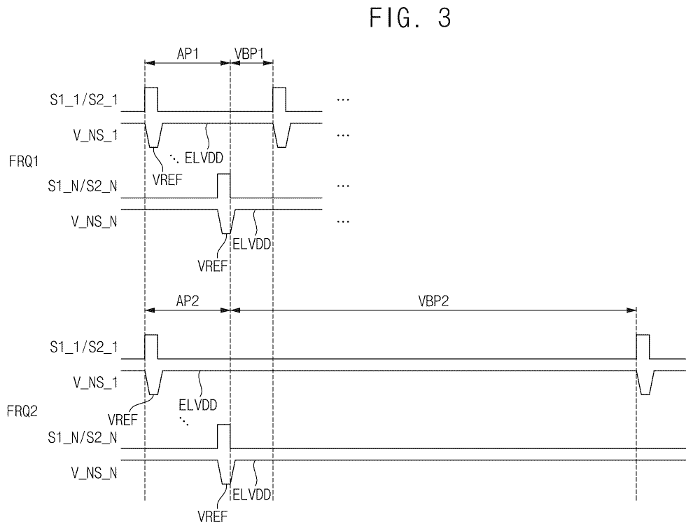

FIG. 3 is a signal timing diagram for describing an operation of the pixel PX at first and second frequencies FRQ1 and FRQ2 when luminance compensation is not performed.

Referring to FIGS. 2 and 3, in an embodiment, the pixel PX may simultaneously receive pulses of the first and second scan signals S1 and S2 in each active period AP1 and AP2. When the pulses of the first and second scan signals S1 and S2 are applied to the pixel PX, the data voltage DV may be applied to the first node NG (i.e., the first terminal of the capacitor CST) and the reference voltage VREF may be applied to the second node NS (i.e., the second terminal of the capacitor CST). Accordingly, when the pulses of the first and second scan signals S1 and S2 are applied to the pixel PX, the capacitor CST may store a difference between the data voltage DV and the reference voltage VREF. When the pulses of the first and second scan signals S1 and S2 are applied to the pixel PX, the light-emitting diode LED may not emit light because the second node NS connected to the first terminal of the light-emitting diode LED has the reference voltage VREF.

A time length of a vertical blank period VBP1 and VBP2 may change depending on the driving frequency. The time length of the vertical blank period VBP1 when the pixel PX is driven at the first frequency FRQ1 may be different from the time length of the vertical blank period VBP2 when the pixel PX is driven at the second frequency FRQ2 different from the first frequency FRQ1. During the same time length, the number of times the pulses of the first and second scan signals S1 and S2 are applied to the pixel PX when the pixel PX is driven at the first frequency FRQ1 (i.e., the number of times the light-emitting diode LED is turned off) may be different from the number of times the pulses of the first and second scan signals S1 and S2 are applied to the pixel PX when the pixel PX is driven at the second frequency FRQ2. Accordingly, when the luminance compensation is not performed, even if the display device displays an image with a same grayscale, a luminance of the display panel 110 may change when the driving frequency of the display panel 110 changes, such that flicker may occur.

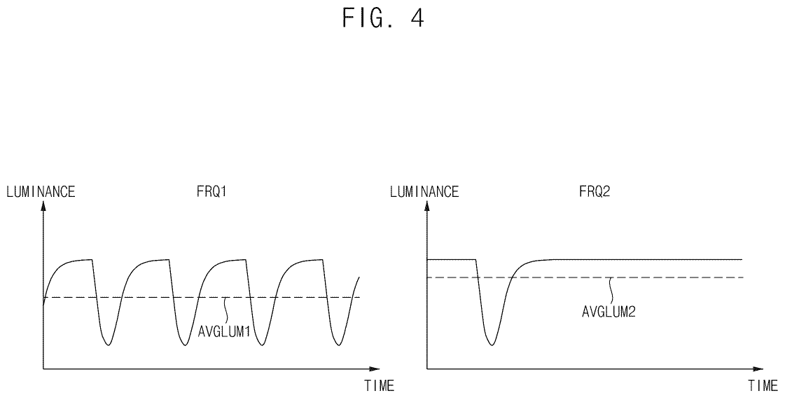

FIG. 4 is a signal timing diagram illustrating a luminance of the pixel PX at the first and second frequencies FRQ1 and FRQ2 when the luminance compensation is not performed.

Referring to FIGS. 2 and 4, when the luminance compensation is not performed, during a same time length, the light-emitting diode LED of the pixel PX driven at the first frequency FRQ1 (e.g., about 240 Hz) may be turned off about 4 times, and the light-emitting diode LED of the pixel PX driven at the second frequency FRQ2 (e.g., about 60 Hz) may be turned off about once. Accordingly, an average luminance AVGLUM2 (e.g., 2.1 nits) of the pixel PX driven at the second frequency FRQ2 may be higher than an average luminance AVGLUM1 (e.g., 1.6 nits) of the pixel PX driven at the first frequency FRQ1.

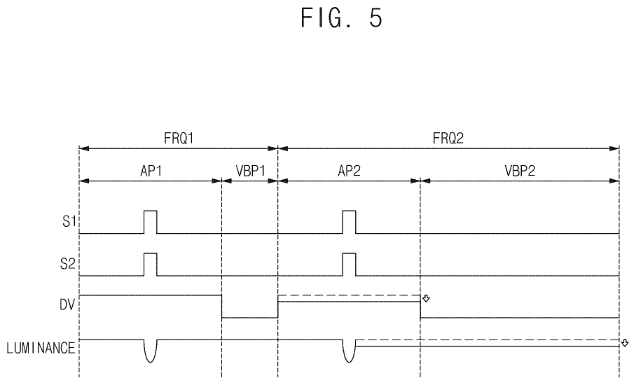

FIG. 5 is a signal timing diagram for describing an operation of the pixel PX at the first and second frequencies FRQ1 and FRQ2 when the luminance compensation is performed by a data compensation method.

Referring to FIGS. 2 and 5, in an embodiment, when the pulse of the first scan signal S1 is applied to the pixel PX, the data voltage DV may be applied to the first node NG (i.e., the first terminal of the capacitor CST), and while the pulse of the second scan signal S2 is not applied to the pixel PX, the light-emitting diode LED may emit light with a luminance corresponding to a voltage level of the data voltage DV applied to the first node NG.

In the data compensation method, i.e., when the luminance compensation is performed by the data compensation method, the data voltage DV may be controlled based on the driving frequency. In the data compensation method, the voltage level of the data voltage DV may decrease as the driving frequency decreases, and the voltage level of the data voltage DV may increase as the driving frequency increases.

When the data compensation method is performed, the voltage level of the data voltage DV applied to the pixel PX driven with the second frequency FRQ2 may be lower than the voltage level of the data voltage DV applied to the pixel PX driven with the first frequency FRQ1 higher than the second frequency FRQ2, and accordingly, a luminance of the pixel PX driven with the second frequency FRQ2 may be lower than a luminance of the pixel PX driven with the first frequency FRQ1. When the data compensation method is performed, even if a length of the vertical blank period VBP2 when the pixel PX is driven with the second frequency FRQ2 is greater than a length of the vertical blank period VBP1 when the pixel PX is driven with the first frequency FRQ1, since the luminance of the pixel PX driven with the second frequency FRQ2 is lower than the luminance of the pixel PX driven with the first frequency FRQ1, an average luminance of the pixel PX driven with the second frequency FRQ2 may be substantially the same as or similar to an average luminance of the pixel PX driven with the first frequency FRQ1. Accordingly, a flicker may be prevented from occurring when the driving frequency of the display panel 110 changes.

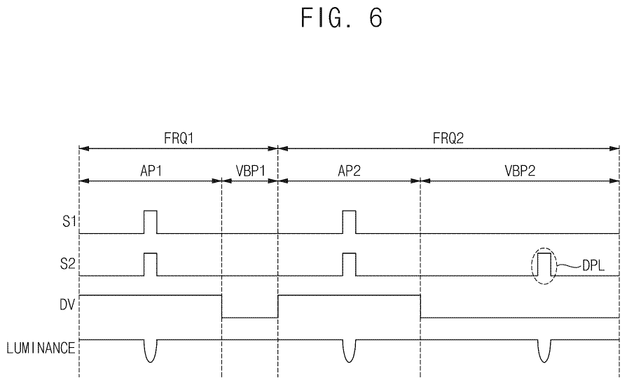

FIG. 6 is a signal timing diagram for describing an operation of the pixel PX at the first and second frequencies FRQ1 and FRQ2 when the luminance compensation is performed by a scan compensation method.

Referring to FIGS. 2 and 6, in an embodiment, when the pulse of the second scan signal S2 is applied to the pixel PX, the reference voltage VREF may be applied to the second node NS (i.e., the second terminal of the capacitor CST), and while the pulse of the second scan signal S2 is applied to the pixel PX, the light-emitting diode LED may not emit light.

In the scan compensation method, i.e., when the luminance compensation is performed by the scan compensation method, the second scan signal S2 may be controlled based on the driving frequency. In the scan compensation method, the number of dummy pulses DPL of the second scan signal S2 within the vertical blank period VBP1 and VBP2 may increase as the driving frequency decreases, and the number of dummy pulses DPL of the second scan signal S2 within the vertical blank period VBP1 and VBP2 may decrease as the driving frequency increases.

When the scan compensation method is performed, the number of dummy pulses DPL of the second scan signal S2 within the vertical blank period VBP2 at the second frequency FRQ2 may be greater than the number of dummy pulses DPL of the second scan signal S2 within the vertical blank period VBP2 at the first frequency FRQ1 higher than the second frequency FRQ2, and accordingly, in the vertical blank period VBP1 and VBP2, the number of times the light-emitting diode LED of the pixel PX driven at the second frequency FRQ2 is turned off may be greater than the number of times the light-emitting diode LED of the pixel PX driven at the first frequency FRQ1 is turned off. When the scan compensation method is performed, even if the length of the vertical blank period VBP2 when the pixel PX is driven with the second frequency FRQ2 is greater than the length of the vertical blank period VBP1 when the pixel PX is driven with the first frequency FRQ1, since the number of times the light-emitting diode LED of the pixel PX driven with the second frequency FRQ2 is turned off is greater than the number of times the light-emitting diode LED of the pixel PX driven with the first frequency FRQ1 is turned off, the average luminance of the pixel PX driven with the second frequency FRQ2 may be substantially the same as or similar to the average luminance of the pixel PX driven with the first frequency FRQ1. Accordingly, a flicker may be effectively prevented from occurring when the driving frequency of the display panel 110 changes.

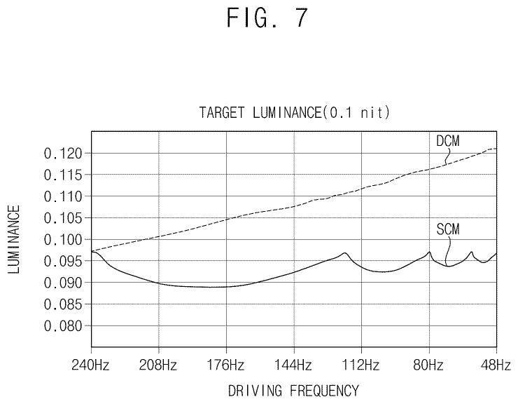

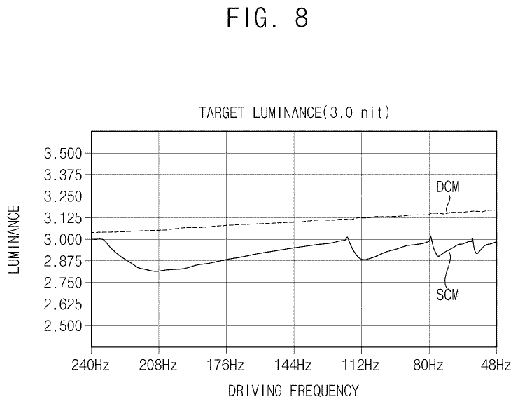

FIG. 7 is a graph illustrating a relationship between a driving frequency and a luminance when the luminance compensation is performed by the data compensation method and the scan compensation method when a luminance of a display device is low. FIG. 8 is a graph illustrating a relationship between a driving frequency and a luminance when the luminance compensation is performed by the data compensation method and the scan compensation method when a luminance of a display device is high.

Referring to FIGS. 1, 7, and 8, in an embodiment, when the luminance of the display device 100 is low (for example, the target luminance is about 0.1 nit), a luminance deviation according to the driving frequency when luminance compensation is performed using the scan compensation method SCM may be less than a luminance deviation according to the driving frequency when luminance compensation is performed using the data compensation method DCM. Further, when the luminance of the display device 100 is high (for example, the target luminance is about 3.0 nit), the luminance deviation according to the driving frequency when luminance compensation is performed using the data compensation method DCM may be less than the luminance deviation according to the driving frequency when luminance compensation is performed using the scan compensation method SCM. Accordingly, the scan compensation method SCM may be desired for luminance compensation when the luminance of the display device 100 is low, and the data compensation method DCM may be desired for luminance compensation when the luminance of the display device 100 is high.

When luminance compensation is performed using the data compensation method DCM, the luminance may generally linearly increase when the driving frequency decreases. Further, when luminance compensation is performed using the scan compensation method SCM, the luminance may repeat periodic decreases and increases when the driving frequency decreases. Accordingly, the data compensation method DCM may be desired for luminance compensation when the difference in driving frequencies between the previous frame and the current frame is small, and the scan compensation method SCM may be desired for luminance compensation when the difference in driving frequencies between the previous frame and the current frame is large.

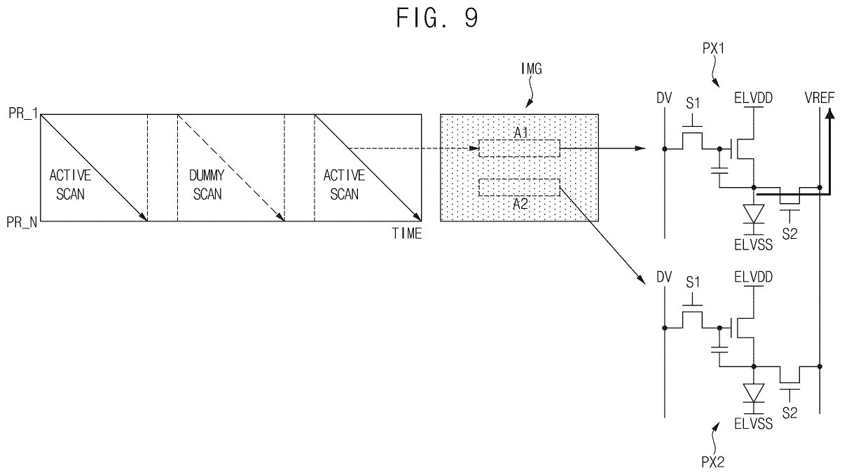

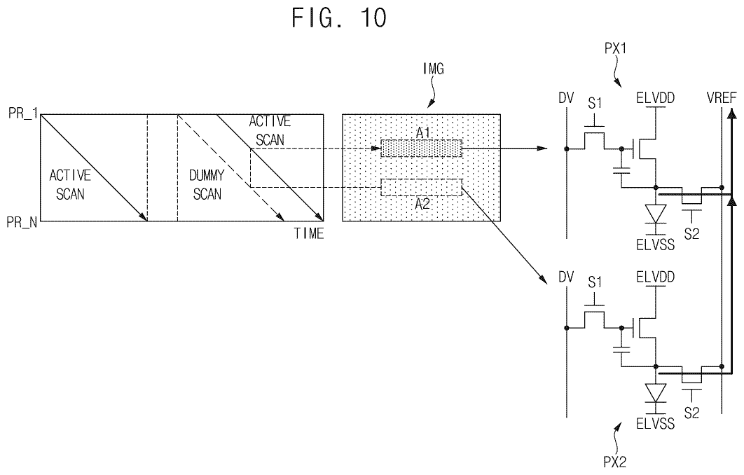

FIG. 9 is a diagram for describing an image IMG and pixels PX1 and PX2 when an active scan period and a dummy scan period do not overlap each other when the luminance compensation is performed by the scan compensation method. FIG. 10 is a diagram for describing an image IMG and pixels PX1 and PX2 when the active scan period and the dummy scan period overlap each other when the luminance compensation is performed by the scan compensation method.

Referring to FIGS. 2, 9, and 10, in an embodiment, when performing luminance compensation by the scan compensation method in a case where an active scan period and a dummy scan period do not overlap each other, at a time point when the pulses of the first and second scan signals S1 and S2 are applied to the first pixel PX1 positioned in a first area A1 of the image IMG, the reference voltage VREF may be applied to the first pixel PX1, and the reference voltage VREF may not be applied to the second pixel PX2 positioned in a second area A2 of the image IMG. When a frequency difference between the driving frequency of the previous frame including the dummy scan period and the driving frequency of the current frame including the active scan period is an integer multiple, the dummy scan period of the previous frame and the active scan period of the current frame may not overlap each other. The active scan period may be a period in which the first scan signals S1 and the second scan signals S2 are simultaneously applied to the pixels PX for writing the data voltages DV and turning off the emission of the pixels PX, and the dummy scan period may be a period in which only the second scan signals S2 are applied to the pixels PX for turning off the emission of the pixels PX. When the reference voltage VREF is applied to the first pixel PX1 and the reference voltage VREF is not applied to the second pixel PX2, a load of the reference voltage line VREFL transmitting the reference voltage VREF may not change, and a voltage of the second node NS of the first pixel PX1 may be equal to the reference voltage VREF. In this case, a voltage stored in the capacitor CST of the first pixel PX1 may not change, and accordingly, a luminance of the first area A1 may not change.

When performing luminance compensation by the scan compensation method in a case where the active scan period and the dummy scan period overlap each other, at a time point when the pulses of the first and second scan signals S1 and S2 are applied to the first pixel PX1 and the pulse of the second scan signal S2 is applied to the second pixel PX2, the reference voltage VREF may be applied to the first pixel PX1 and the second pixel PX2. When the frequency difference between the driving frequency of the previous frame including the dummy scan period and the driving frequency of the current frame including the active scan period is not an integer multiple, the dummy scan period of the previous frame and the active scan period of the current frame may overlap each other. When the reference voltage VREF is applied to both the first pixel PX1 and the second pixel PX2, the load of the reference voltage line VREFL for transmitting the reference voltage VREF may change, and the voltage of the second node NS of the first pixel PX1 may be different from the reference voltage VREF. In this case, the voltage stored in the capacitor CST of the first pixel PX1 may change, and accordingly, the luminance of the first area A1 may change. In this case, the image IMG may include a ghost positioned in the first area A1. Accordingly, the data compensation method may be desired for luminance compensation when the image IMG includes the ghost, and the scan compensation method may be desired for luminance compensation when the image IMG does not include the ghost.

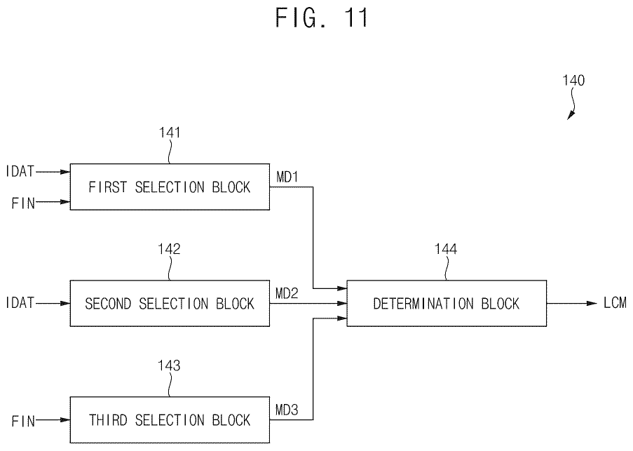

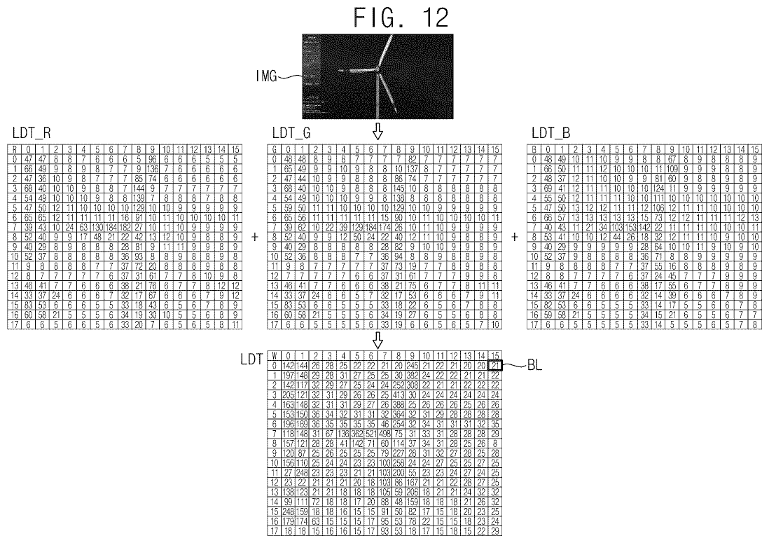

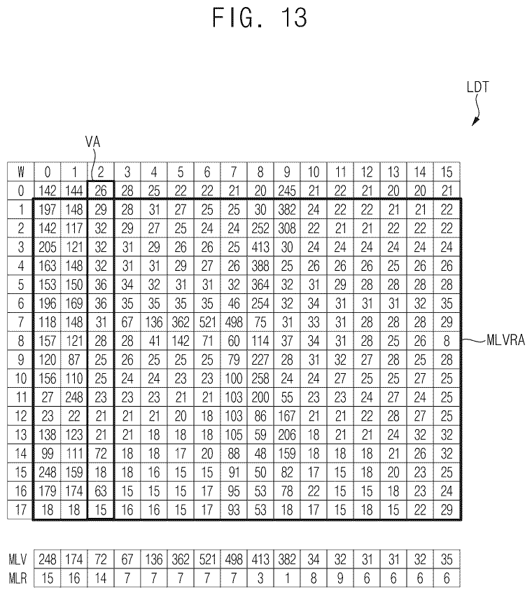

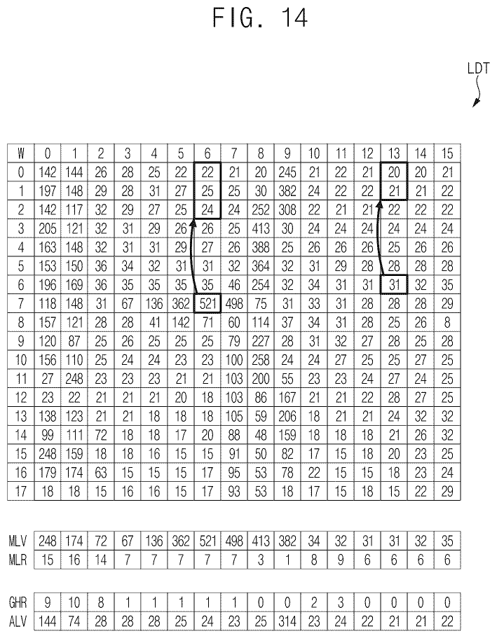

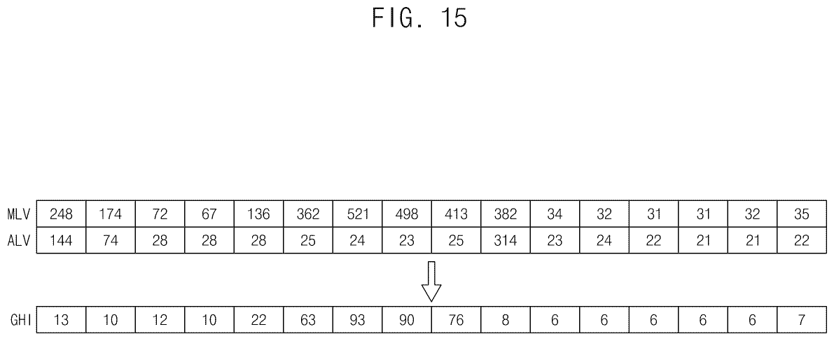

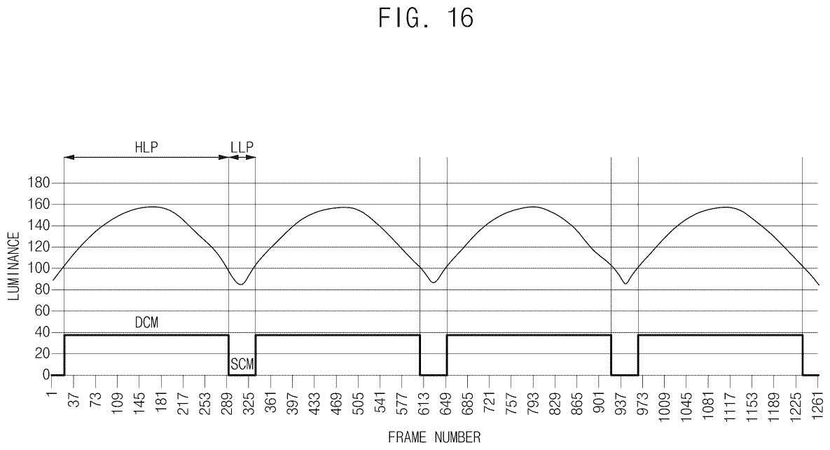

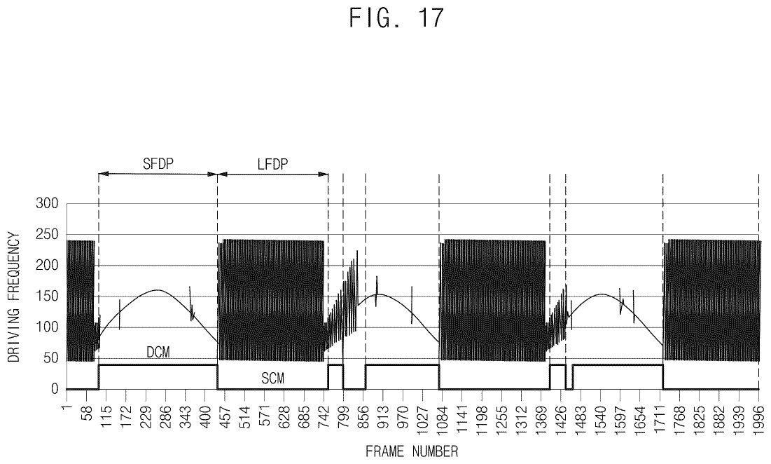

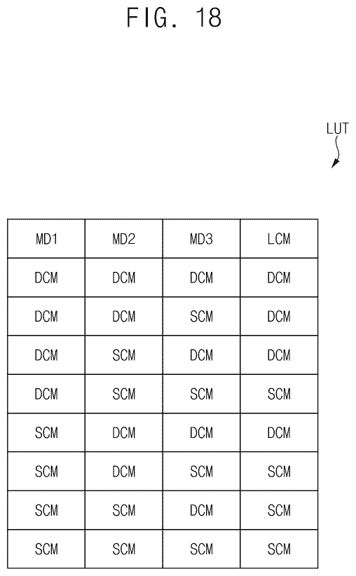

FIG. 11 is a block diagram illustrating the controller 140 of FIG. 1. FIG. 12 is a diagram for describing an operation to calculate luminance data LDT based on the input image data IDAT. FIG. 13 is a diagram for describing an operation to calculate maximum luminance values MLV for vertical areas VA and maximum luminance rows MLR in which the maximum luminance values MLV are positioned based on the luminance data LDT. FIG. 14 is a diagram for describing an operation to calculate ghost rows GHR for the vertical areas VA based on the maximum luminance rows MLR and frequency information FIN, and to calculate average luminance values ALV corresponding to the ghost rows GHR based on the luminance data LDT. FIG. 15 is a diagram for describing an operation to calculate ghost indexes GHI for the vertical area VA based on the maximum luminance values MLV and the average luminance values ALV. FIG. 16 is a diagram for describing an operation to select one of the data compensation method DCM and the scan compensation method SCM as a second method MD2 by determining a luminance. FIG. 17 is a diagram for describing an operation to select one of the data compensation method DCM and the scan compensation method SCM as a third method MD3 by determining a frequency difference. FIG. 18 is a diagram illustrating an example of a lookup table LUT which stores a luminance compensation method LCM corresponding to a first method MD1, the second method MD2, and the third method MD3.

Referring to FIGS. 11 to 18, in an embodiment, the controller 140 may include a first selection block 141, a second selection block 142, a third selection block 143, and a determination block 144.

The first selection block 141 may select one of the data compensation method DCM and the scan compensation method SCM as the first method MD1 by determining whether the image IMG includes the ghost based on the input image data IDAT and frequency information FIN. The first selection block 141 may select the data compensation method DCM as the first method MD1 when the image IMG includes the ghost, and may select the scan compensation method SCM as the first method MD1 when the image IMG does not include the ghost.

As illustrated in FIG. 12, the first selection block 141 may calculate luminance data LDT including luminance values for a plurality of blocks BL that divide the image IMG based on the input image data IDAT. In an embodiment, for example, the image IMG may be divided into 288 blocks BL arranged in 18 rows (zeroth to seventeenth rows) and 16 columns (zeroth to fifteenth columns). In an embodiment, the first selection block 141 may generate red luminance data LDT_R including red luminance values for the blocks BL, green luminance data LDT_G including green luminance values for the blocks BL, and blue luminance data LDT_B including blue luminance values for the blocks BL based on input image data IDAT, and may generate the luminance data LDT by adding the red luminance values of the red luminance data LDT_R, the green luminance values of the green luminance data LDT_G, and the blue luminance values of the blue luminance data LDT_B.

As illustrated in FIG. 13, the first selection block 141 may calculate the maximum luminance values MLV for the vertical areas VA that divide the image IMG based on the luminance data LDT and the maximum luminance rows MLR in which the maximum luminance values MLV are positioned. Each vertical area VA may include a plurality of blocks BL arranged in a column direction. In an embodiment, for example, each vertical area VA may include 18 blocks BL arranged in the column direction. In an embodiment, the first selection block 141 may calculate the maximum luminance values MLV from a maximum luminance value retrieve area MLVRA. In an embodiment, for example, the maximum luminance value retrieve area MLVRA may include blocks BL arranged in the first to seventeenth rows and the zeroth to fifteenth columns. In this case, the first selection block 141 may calculate the maximum luminance value MLV from the blocks BL positioned in the first to seventeenth rows of each vertical area VA. In an embodiment, when a plurality of blocks BL in the vertical area VA has the maximum luminance value MLV, a row of the block BL positioned in the highest row among the blocks BL may be calculated as the maximum luminance row MLR.

As illustrated in FIG. 14, the first selection block 141 may calculate the ghost rows GHR for the vertical areas VA based on the maximum luminance rows MLR and the frequency information FIN, and may calculate the average luminance values ALV corresponding to the ghost rows GHR based on the luminance data LDT. In an embodiment, for example, when it is determined that a difference between the maximum luminance row MLR and the ghost row GHR is 6 rows based on the frequency information FIN, the first selection block 141 may calculate the ghost rows GHR by subtracting 6 from the maximum luminance rows MLR. In this case, when the calculated ghost row GHR is less than 0, 0 may be input to the ghost row GHR.

The average luminance value ALV corresponding to the ghost row GHR may be calculated as the average value of the luminance values of the ghost row GHR, a row above the ghost row GHR, and a row below the ghost row GHR. When the value of the ghost row GHR is 0, the average luminance value ALV corresponding to the ghost row GHR may be calculated as the average value of the luminance values of the ghost row GHR and the row below the ghost row GHR. In an embodiment, as shown in FIG. 14, in the vertical area VA positioned in the sixth column, the value of the ghost row GHR may be 1 (=7−6), and the average luminance value ALV may be 24 (≈(22+25+24)/3). In an embodiment, as shown in FIG. 14, in the vertical area VA positioned in the thirteenth column, the value of the ghost row GHR may be 0 (=6−6), and the average luminance value ALV may be 21 (≈(20+21)/2).

In an embodiment, as illustrated in FIG. 15, the first selection block 141 may calculate the ghost indexes GHI for the vertical areas VA based on the maximum luminance values MLV and the average luminance values ALV. The ghost index GHI may mean the degree to which ghosts are recognized in each vertical area VA. In an embodiment, in each vertical area VA, the ghost index GHI may increase as the difference between the maximum luminance value MLV and the average luminance value ALV increases, and the ghost index GHI may increase as the average luminance value ALV decreases. Since the luminance deviation between the maximum luminance value MLV and the average luminance value ALV increases as the difference between the maximum luminance value MLV and the average luminance value ALV increases, the degree to which ghosts are recognized in the ghost row GHR may increase as the difference between the maximum luminance value MLV and the average luminance value ALV increases. Further, since the luminance of the ghost row GHR decreases as the average luminance value ALV decreases, the degree to which ghosts are recognized in the ghost row GHR may increase as the average luminance value ALV decreases.

The first selection block 141 may determine vertical areas VA whose ghost index GHI is greater than or equal to a threshold index as ghost areas among vertical areas VA. In an embodiment, as shown in FIG. 15, when the threshold index is 60, the number of ghost areas may be 4. The first selection block 141 may select the data compensation method DCM as the first method MD1 when the number of ghost areas is greater than or equal to a threshold number, and may select the scan compensation method SCM as the first method MD1 when the number of ghost areas is less than the threshold number.

The second selection block 142 may select one of the data compensation method DCM and the scan compensation method SCM as the second method MD2 by determining the luminance of the image IMG based on the input image data IDAT. The second selection block 142 may select the data compensation method DCM as the second method MD2 when the luminance of the image IMG is greater than or equal to a reference luminance, and may select the scan compensation method SCM as the second method MD2 when the luminance of the image IMG is less than the reference luminance.

In an embodiment, as illustrated in FIG. 12, the second selection block 142 may calculate the luminance data LDT including the luminance values for the plurality of blocks BL that divide the image IMG based on the input image data IDAT. In an embodiment, the second selection block 142 may calculate the red luminance data LDT_R, the green luminance data LDT_G, and the blue luminance data LDT_B based on the input image data IDAT, and may calculate the luminance data LDT by adding the red luminance values of the red luminance data LDT_R, the green luminance values of the green luminance data LDT_G, and the blue luminance values of the blue luminance data LDT_B.

In an embodiment, the luminance of the image IMG may be one of an average value of the luminance values, a maximum value of the luminance values, a minimum value of the luminance values, and a representative value of the luminance values. In an embodiment, for example, the representative value of the luminance values may be the luminance value of a predetermined block BL.

In an embodiment, as shown in FIG. 16, when the reference luminance is 100 nit, the second selection block 142 may select the data compensation method DCM as the second method MD2 in a high luminance period HLP where the luminance of the image IMG is greater than or equal to 100 nit, and may select the scan compensation method SCM as the second method MD2 in a low luminance period LLP where the luminance of the image IMG is less than 100 nit.

The third selection block 143 may select one of the data compensation method DCM and the scan compensation method SCM as the third method MD3 by determining a frequency difference based on the frequency information FIN. The third selection block 143 may select the data compensation method DCM as the third method MD3 when the frequency difference is less than or equal to a reference difference, and may select the scan compensation method SCM as the third method MD3 when the frequency difference is greater than the reference difference.

In an embodiment, the frequency difference may be a difference between the driving frequency of the current frame and the driving frequency of the previous frame. In an embodiment, for example, the third selection block 143 may calculate the driving frequency using the vertical synchronization signal included in the control signal CTRL of FIG. 1 for each frame.

In an embodiment, the third selection block 143 may increase a count value when the frequency difference is greater than the reference difference, and may select the scan compensation method SCM as the third method MD3 when the count value is greater than or equal to a reference count value. Accordingly, when the driving frequency temporarily significantly changes, the third selection block 143 may be effectively prevented from frequently changing the third method MD3 between the data compensation method DCM and the scan compensation method SCM.

In an embodiment, as shown in FIG. 17, the third selection block 143 may select the data compensation method DCM as the third method MD3 in a low frequency difference period SFDP where the frequency difference is less than or equal to the reference difference, and may select the scan compensation method SCM as the third method MD3 in a high frequency difference period LFDP where the frequency difference is greater than the reference difference.

The determination block 144 may determine one of the first method MD1, the second method MD2, and the third method MD3 as the luminance compensation method LCM. In an embodiment, the determination block 144 may determine the luminance compensation method LCM by referencing the lookup table LUT that stores the luminance compensation method LCM corresponding to the first method MD1, the second method MD2, and the third method MD3. In an embodiment, as illustrated in FIG. 18, the lookup table LUT may store the luminance compensation method LCM corresponding to the first method MD1, the second method MD2, and the third method MD3 in advance.

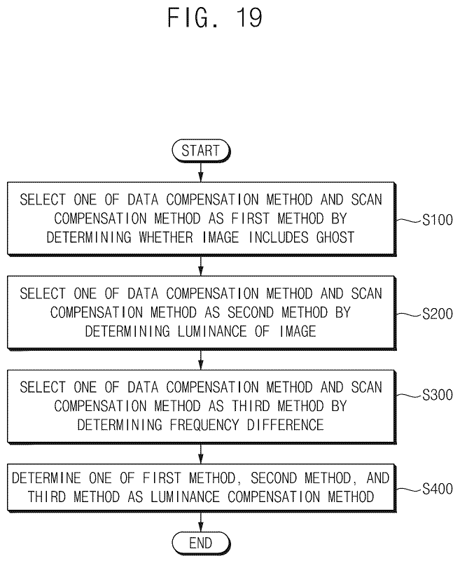

FIG. 19 is a flowchart illustrating a method of driving a display device according to an embodiment.

Referring to FIGS. 11 to 19, in an embodiment of the method of driving the display device, the first selection block 141 may select one of the data compensation method DCM and the scan compensation method SCM as the first method MD1 by determining whether the image IMG includes the ghost based on the input image data IDAT and the frequency information FIN (S100). The first selection block 141 may select the data compensation method DCM as the first method MD1 when the image IMG includes the ghost, and may select the scan compensation method SCM as the first method MD1 when the image IMG does not include the ghost.

The second selection block 142 may select one of the data compensation method DCM and the scan compensation method SCM as the second method MD2 by determining the luminance of the image IMG based on the input image data IDAT (S200). The second selection block 142 may select the data compensation method DCM as the second method MD2 when the luminance of the image IMG is greater than or equal to the reference luminance, and may select the scan compensation method SCM as the second method MD2 when the luminance of the image IMG is less than the reference luminance.

The third selection block 143 may select one of the data compensation method DCM and the scan compensation method SCM as the third method MD3 by determining the frequency difference based on the frequency information FIN (S300). The third selection block 143 may select the data compensation method DCM as the third method MD3 when the frequency difference is less than or equal to the reference difference, and may select the scan compensation method SCM as the third method MD3 when the frequency difference is greater than the reference difference.

The determination block 144 may determine one of the first method MD1, the second method MD2, and the third method MD3 as the luminance compensation method LCM (S400).

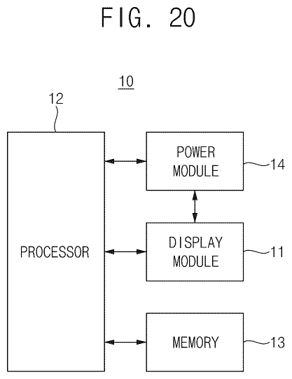

FIG. 20 is a block diagram illustrating an electronic device 10 according to an embodiment.

Referring to FIG. 20, an embodiment of the electronic device 10 may include a display module 11, a processor 12, a memory 13, and a power module 14.

The processor 12 may include at least one selected from a central processing unit (CPU), an application processor (AP), a graphic processing unit (GPU), a communication processor (CP), an image signal processor (ISP), and a controller.

The memory 13 may store data information for an operation of the processor 12 or the display module 11. When the processor 12 executes an application stored in the memory 13, the input image data IDAT of FIG. 1 and the control signal CTRL of FIG. 1 may be transmitted to the display module 11, and the display module 11 may output image information based on the input image data IDAT and the control signal CTRL.

The power module 14 may include a power supply module such as a power adapter, a battery device, etc. and a power conversion module that converts power supplied by the power supply module to generate power for an operation of the electronic device 10.

At least one of the components of the electronic device 10 described above may be included in the display device 100 of FIG. 1 according to embodiments described above. Further, some of individual modules functionally included in one module may be included in the display device 100, and others may be provided separately from the display device 100. In an embodiment, for example, the display device 100 may include the display module 11, and the processor 12, the memory 13, and the power module 14 may be provided in the form of other devices within the electronic device 11 other than the display device 100.

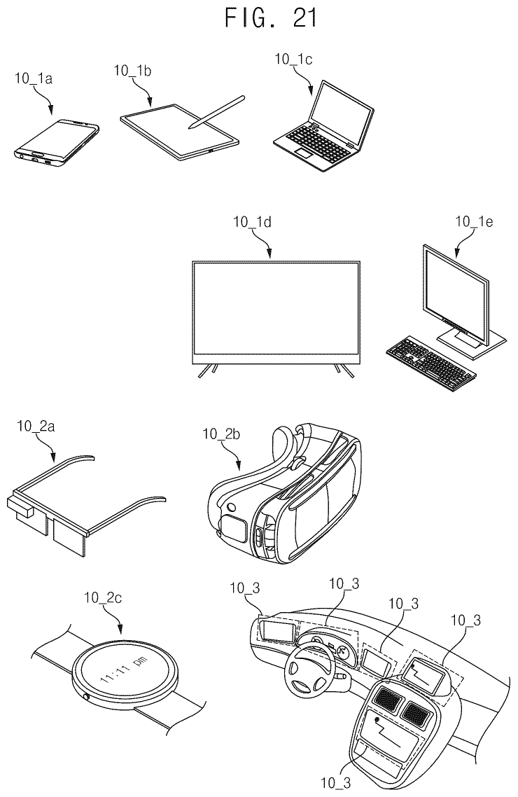

FIG. 21 is a diagram illustrating electronic devices according to embodiments.

Referring to FIG. 21, electronic devices to which display devices according to embodiments are applied may include not only image display electronic devices such as a smart phone 10_1a, a tablet personal computer (PC) 10_1b, a laptop computer 10_1c, a television (TV) 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display (CID) arranged on a dashboard, a room mirror display, etc.

The display device according to the embodiments may be applied to a display device included in a computer, a notebook, a mobile phone, a smart phone, a smart pad, a smart watch, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including a pixel;
a data driver which provides a data voltage to the pixel;
a scan driver which provides a first scan signal and a second scan signal to the pixel; and
a controller which controls the data driver and the scan driver,
wherein the controller includes:
a first selection block which selects one of a data compensation method and a scan compensation method as a first method by determining whether an image includes a ghost based on input image data and frequency information, wherein the data voltage is controlled based on a driving frequency when the data compensation method is performed, and the second scan signal is controlled based on the driving frequency when the scan compensation method is performed;
a second selection block which selects one of the data compensation method and the scan compensation method as a second method by determining a luminance of the image based on the input image data;
a third selection block which selects one of the data compensation method and the scan compensation method as a third method by determining a frequency difference based on the frequency information; and
a determination block which determines one of the first method, the second method, and the third method as a luminance compensation method.

2. The display device of claim 1, wherein, when the data compensation method is performed, a voltage level of the data voltage decreases as the driving frequency decreases.

3. The display device of claim 1, wherein, when the scan compensation method is performed, a number of dummy pulses of the second scan signal within a vertical blank period having a variable time length increases as the driving frequency decreases.

4. The display device of claim 1, wherein the first selection block selects the data compensation method as the first method when the image includes the ghost, and selects the scan compensation method as the first method when the image does not include the ghost.

5. The display device of claim 1, wherein the first selection block determines vertical areas, in which a ghost index is greater than or equal to a threshold index, as ghost areas among a plurality of vertical areas, selects the data compensation method as the first method when a number of the ghost areas is greater than or equal to a threshold number, and selects the scan compensation method as the first method when the number of the ghost areas is less than the threshold number.

6. The display device of claim 5, wherein the first selection block calculates luminance data including luminance values for a plurality of blocks, which divides the image, based on the input image data, calculates a maximum luminance value for each of the vertical areas and a maximum luminance row, in which the maximum luminance value is positioned, based on the luminance data, calculates a ghost row for each of the vertical areas based on the maximum luminance row and the frequency information, calculates an average luminance value corresponding to the ghost row based on the luminance data, and calculates a ghost index for each of the vertical areas based on the maximum luminance value and the average luminance value.

7. The display device of claim 6, wherein the ghost index increases as a difference between the maximum luminance value and the average luminance value increases, and
wherein the ghost index increases as the average luminance value decreases.

8. The display device of claim 1, wherein the second selection block selects the data compensation method as the second method when the luminance of the image is greater than or equal to a reference luminance, and selects the scan compensation method as the second method when the luminance of the image is less than the reference luminance.

9. The display device of claim 8, wherein the second selection block calculates luminance data including luminance values for a plurality of blocks, which divides the image, based on the input image data, and
wherein the luminance of the image is one of an average value of the luminance values, a maximum value of the luminance values, a minimum value of the luminance values, and a representative value of the luminance values.

10. The display device of claim 1, wherein the third selection block selects the data compensation method as the third method when the frequency difference is less than or equal to a reference difference, and selects the scan compensation method as the third method when the frequency difference is greater than the reference difference.

11. The display device of claim 10, wherein the frequency difference is a difference between the driving frequency of a current frame and the driving frequency of a previous frame.

12. The display device of claim 1, wherein the determination block determines the luminance compensation method by referencing a lookup table which stores the luminance compensation method corresponding to the first method, the second method, and the third method.

13. The display device of claim 1, wherein the pixel includes:
a first transistor including a gate connected to a first node, a first terminal which receives a first power voltage, and a second terminal connected to a second node;
a second transistor including a gate which receives the first scan signal, a first terminal which receives the data voltage, and a second terminal connected to the first node;
a third transistor including a gate which receives the second scan signal, a first terminal which receives a reference voltage, and a second terminal connected to the second node;
a capacitor including a first terminal connected to the first node and a second terminal connected to the second node; and
a light-emitting diode including a first terminal connected to the second node and a second terminal which receives a second power voltage.

14. A method of driving a display device, the method comprising:
selecting one of a data compensation method w and a scan compensation method as a first method by determining whether an image includes a ghost based on input image data and frequency information, wherein a data voltage is controlled based on a driving frequency when the data compensation method is performed, and a scan signal is controlled based on the driving frequency when the scan compensation method is performed;
selecting one of the data compensation method and the scan compensation method as a second method by determining a luminance of the image based on the input image data;
selecting one of the data compensation method and the scan compensation method as a third method by determining a frequency difference based on the frequency information; and
determining one of the first method, the second method, and the third method as a luminance compensation method.

15. The method of claim 14, wherein, when the data compensation method is performed, a voltage level of the data voltage decreases as the driving frequency decreases.

16. The method of claim 14, wherein, when the scan compensation method is performed, a number of dummy pulses of the scan signal within a vertical blank period having a variable time length increases as the driving frequency decreases.

17. The method of claim 14, wherein, in the selecting one of the data compensation method and the scan compensation method as the first method, the data compensation method is selected as the first method when the image includes the ghost, and the scan compensation method is selected as the first method when the image does not include the ghost.

18. The method of claim 14, wherein, in the selecting one of the data compensation method and the scan compensation method as the second method, the data compensation method is selected as the second method when the luminance of the image is greater than or equal to a reference luminance, and the scan compensation method is selected as the second method when the luminance of the image is less than the reference luminance.

19. The method of claim 14, wherein, in the selecting one of the data compensation method and the scan compensation method as the third method, the data compensation method is selected as the third method when the frequency difference is less than or equal to a reference difference, and the scan compensation method is selected as the third method when the frequency difference is greater than the reference difference.

20. An electronic device, comprising:
a processor;
a memory connected to the processor;
a power module connected to the processor; and
a display device which receives input image data from the processor, and displays an image corresponding to the input image data,
wherein the display device comprises:
a display panel including a pixel;
a data driver which provides a data voltage to the pixel;
a scan driver which provides a first scan signal and a second scan signal to the pixel; and
a controller which controls the data driver and the scan driver,
wherein the controller includes:
a first selection block which selects one of a data compensation method and a scan compensation method as a first method by determining whether the image includes a ghost based on the input image data and frequency information, wherein the data voltage is controlled based on a driving frequency when the data compensation method is performed, and the second scan signal is controlled based on the driving frequency when the scan compensation method is performed;
a second selection block which selects one of the data compensation method and the scan compensation method as a second method by determining a luminance of the image based on the input image data;
a third selection block which selects one of the data compensation method and the scan compensation method as a third method by determining a frequency difference based on the frequency information; and
a determination block which determines one of the first method, the second method, and the third method as a luminance compensation method.
